(19) United States
(12) Patent Application Publication
(10) Pub. No.: US 2019/0171185 A1
(43) Pub. Date: Jun. 6, 2019

(54) TOOL SETTING DEVICE AND TOOL-SETTING METHOD FOR ELECTROCHEMICAL MACHINING

(71) Applicant: METAL INDUSTRIES RESEARCH & DEVELOPMENT CENTRE, Kaohsiung City (TW)

(72) Inventors: MING-YOU MA, KAOHSIUNG CITY (TW); DA-YU LIN, KAOHSIUNG CITY (TW); WEN-CHIN CHIANG, KAOHSIUNG CITY (TW); CHIU-FENG LIN, KAOHSIUNG CITY (TW)

(21) Appl. No.: 15/854,180

(22) Filed: Dec. 26, 2017

(30) Foreign Application Priority Data
Dec. 1, 2017 (TW) 106142310

(51) Int. Cl. G05B 19/4093; B23H 3/02

(52) U.S. Cl. CPC G05B 19/40938; G05B 2219/45221; B23H 3/02

(57) ABSTRACT

The present invention relates to a tool setting device and tool-setting method for electrochemical machining. The tool setting device comprises a motion module, a detection circuit, and a tool setting circuit. The motion module moves a machining electrode. The detection circuit detects an electrical status of the machining electrode and outputs an electrical signal. The tool setting circuit performs calculations according to the electrical signal and gives a change status of the electrical signal. In addition, the tool setting circuit controls the motion module according to the change status of the electrical signal for completing the tool setting procedure.

### FIELD OF THE INVENTION

The present invention relates generally to electrochemical machining, and particularly to a tool setting device and tool-setting method for electrochemical machining.

### BACKGROUND OF THE INVENTION

Electrochemical machining is a process in which electrochemical anode dissolution occurs to a metal workpiece in electrolyte. Before performing electrochemical machining on a workpiece, a tool setting procedure must be performed to the machining electrode. In other words, the machining electrode should be positioned with respect to the workpiece for giving the relation between the coordinates of the machining electrode and of the workpiece. According to the prior art, tool setting is achieved by operators measuring using tools for aligning the machining electrode with the workpiece. This manual tool setting procedure is quite time-consuming. Owing to its complicated steps, large tool-setting errors may occur.

Accordingly, the present invention provides an automatic tool setting device and tool-setting method to solve the drawbacks in the manual tool setting method according to the prior art.

### SUMMARY

An objective of the present invention is to provide a tool setting device and tool-setting method for electrochemical machining. In the tool setting procedure performed according to the present invention, the location of the machining electrode can be detected automatically, and the movement of the machining electrode can be controlled as well.

The tool setting device disclosed in the present invention comprises a motion module, a detection circuit, and a tool setting circuit. The motion module moves a machining electrode. The detection circuit detects an electrical status of the machining electrode and outputs an electrical signal. The tool setting circuit performs calculations according to the electrical signal and gives a change status of the electrical signal. In addition, the tool setting circuit controls the motion module according to the change status of the electrical signal.

The tool-setting method disclosed in the present invention comprises moving a machining electrode; detecting an electrical status of the machining electrode and outputting an electrical signal; performing calculations according to the electrical signal and giving a change status of the electrical signal; and controlling the moving speed of the machining electrode according to the change status of the electrical signal.

### BRIEF DESCRIPTION OF THE DRAWINGS

FIG. 1 shows a schematic diagram of the tool setting device for electrochemical machining according to an embodiment of the present invention;

FIG. 2A shows a schematic diagram of a first motion for tool setting as the tool setting device for electrochemical machining according to the present invention moves the machining electrode;

FIG. 2B shows a schematic diagram of a second motion for tool setting as the tool setting device for electrochemical machining according to the present invention moves the machining electrode;

FIG. 2C shows a schematic diagram of a third motion for tool setting as the tool setting device for electrochemical machining according to the present invention moves the machining electrode;

FIG. 3A shows a schematic diagram of the levels of the electrical signal as the tool setting device according to a first embodiment of the present invention moves the machining electrode for performing tool setting procedure;

FIG. 3B shows a schematic diagram of the changing rate of the electrical signal as the tool setting device according to a first embodiment of the present invention moves the machining electrode for performing tool setting procedure;

FIG. 4A shows a schematic diagram of the levels of the electrical signal as the tool setting device according to a second embodiment of the present invention moves the machining electrode for performing tool setting procedure; and

FIG. 4B shows a schematic diagram of the changing rate of the electrical signal as the tool setting device according to a second embodiment of the present invention moves the machining electrode for performing tool setting procedure.

### DETAILED DESCRIPTION

In order to make the structure and characteristics as well as the effectiveness of the present invention to be further understood and recognized, the detailed description of the present invention is provided as follows along with embodiments and accompanying figures.

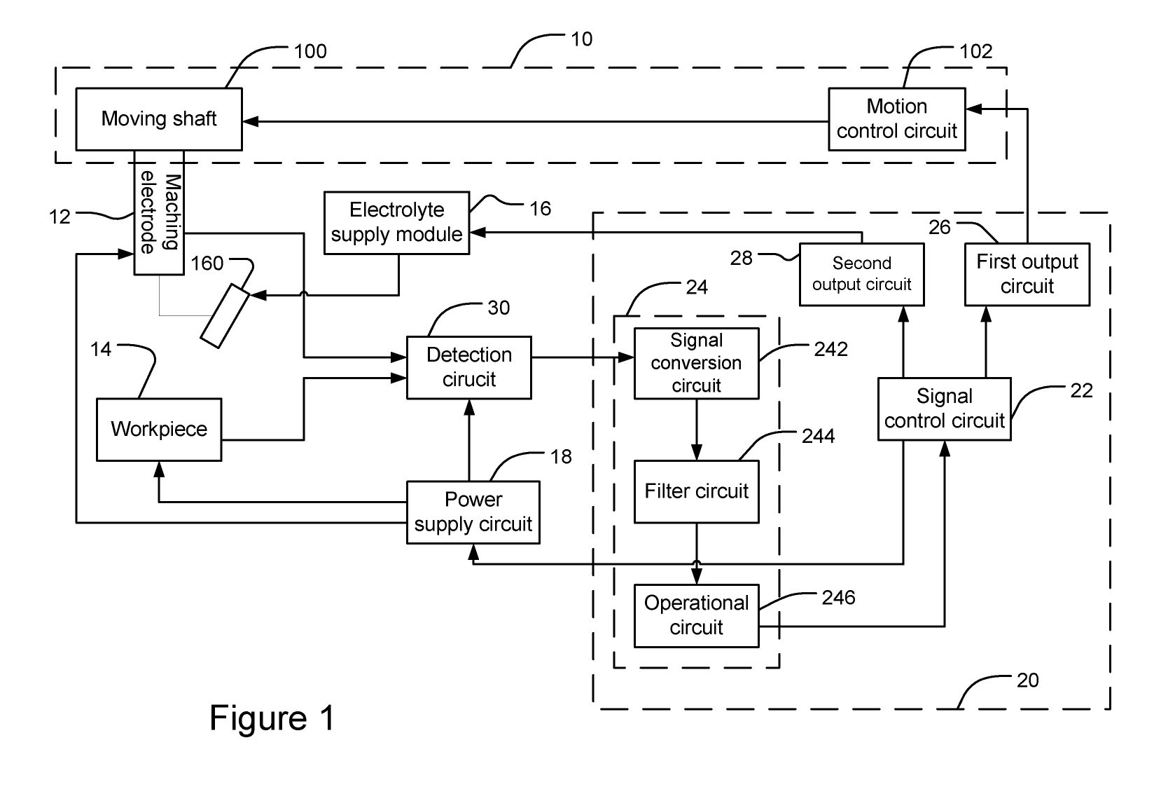

Please refer to FIG. 1, which shows a schematic diagram of the tool setting device for electrochemical machining according to an embodiment of the present invention. As shown in the figure, the tool setting device can control the machining electrode 12 to move to a workpiece 14 and thus performing tool setting procedure. An electrolyte supplies module 16 can supply electrolyte to an electrolyte output device 160 for injecting electrolyte to the surface of the workpiece 14. A power supply circuit 18 is coupled to the machining electrode 12 and the workpiece 14 for supplying a tool-setting power source to the machining electrode 12 and the workpiece 14.

Please refer again to Figure. The tool setting device comprises a motion module 10, a tool setting circuit 20, and a detection circuit 30. The electrolyte supply module 16 and the power supply 18 are not limited to be disposed at the tool setting device. The machining electrode 12 is connected to the motion module 10, which can move the machining electrode 12. The tool setting circuit 20 is coupled to the motion module 10. The detection circuit 30 is coupled to the machining electrode 12 and the workpiece 14 for detecting the electrical status, for example, current or voltage, of the machining electrode 12 and the workpiece 14 and generating an electrical signal correspondingly for representing the detected electrical status. In addition, the detection circuit 30 is further coupled to the tool setting circuit 20 for outputting the electrical signal to the tool setting circuit 20. Thereby, the tool setting circuit 20 can perform calculations according to the electrical signal and thus giving the change status of the electrical signal. Then the tool setting circuit 20 can give the location of the machining electrode 12 with respect to the workpiece 14 according to the change status, and thus controlling the motion module 10 according to the change status for controlling the movement of the machining electrode 12 to perform tool setting procedure. Besides, the tool setting circuit 20 can adjust the moving speed of the machining electrode 12 automatically in the tool setting procedure and hence enhancing tool setting efficiency. Furthermore, it is not required to build a complicated database for tool setting. Consequently, the tool setting hardware can be simplified, and the setup cost can be reduced.

As shown in FIG. 1, the motion module 10 includes a moving shaft 100 and a motion control circuit 102. The machining electrode 12 is fixed to the moving shaft 100, which can drive to the machining electrode 12 to move. The motion control circuit 102 is coupled to the moving shaft 100 for controlling the moving shaft 100 to move. The tool setting circuit 20 controls the motion control circuit 102 of the motion module 10 for controlling the machining electrode 12 to move. The tool setting circuit 20 includes a signal control circuit 22 a signal processing circuit 24. The signal processing circuit 24 is coupled to the detection circuit 30. The signal control circuit 22 is coupled to the signal processing circuit 24 and the power supply circuit 18. In the tool setting procedure, the signal control circuit 22 generates a power control signal and transmits it to the power supply circuit 18. The power supply circuit 18 supplies the tool-setting power source to the machining electrode 12 and the workpiece 14 according to the power control signal as well as a power source to the detection circuit 30. Given the condition of not influencing the accuracy of tool setting procedure, the level of the tool-setting power source output by the power supply circuit 18 is lower than the level of a machining power source supplied for performing electrochemical machining. Thereby, the tool setting device does not use the tool-setting power source for performing the tool setting procedure. The power consumption for the tool setting procedure can be hence reduced.

The detection circuit 30 detects the electrical status of the machining electrode 12 when the machining electrode 12 moves to the workpiece 14 and outputs the electrical signal to the signal processing circuit 24. The signal processing circuit 24 receives the electrical signal, performs calculations according to the electrical signal, gives a change status of the electrical signal, and outputs a signal to the signal control circuit 22 correspondingly. The signal control circuit 22 receives the signal transmitted by the signal processing circuit 24 and acquires the change status of the electrical signal. According to the change status, the signal control circuit 22 can deduce the location of the machining electrode 12 with respect to the workpiece 14. Then it can control the motion module 10 according to the change status and thus controlling the movement of the machining electrode 12. Besides, it can also adjust the moving speed of the machining electrode 12. Consequently, as the machining electrode 12 approaches the workpiece 14, the moving speed of the machining electrode 12 can be reduced.

While adjusting the moving speed of the machining electrode 12, it is not limited to adjust from a high speed to a low speed. If the initial speed of the machining electrode 12 is too low and the machining electrode 12 is not detected to approach the workpiece 14 after a specific time, such as 3 seconds, the signal control circuit 22 can control the motion module 10 to increase the moving speed of the machining electrode 12. Accordingly, the signal control circuit 22 can control the motion module 10 automatically according to the change status of the electrical signal and the moving time of the machining electrode 12 for adjusting the moving speed of the machining electrode 12 automatically.

Please refer again to FIG. 1. The signal processing circuit 24 includes a signal conversion circuit 242, a filter circuit 244, and an operational circuit 246. The signal conversion circuit 242 is coupled to the detection circuit 30. The filter circuit 244 is coupled to the signal conversion circuit 242. The operational circuit 246 is coupled to the filter circuit 244 and the signal control circuit 22. The signal conversion circuit 242 receives the electrical signal output by the detection circuit 30, converts the electrical signal from an analog format to a digital format, and outputs the digital electrical signal to the filter circuit 244. The filter circuit 244 receives the digital electrical signal, filters the noise in the digital electrical signal, and outputs the filtered electrical signal to the operational circuit 246. The operational circuit 246 receives the filtered electrical signal, performs calculation according to the filtered electrical signal to give the changes status of the electrical signal, and outputs the corresponding signal to the signal control circuit 22. According to the embodiment of FIG. 1, if the format of the electrical signal output by the detection circuit 30 is digital, the signal processing circuit 24 may exclude the signal conversion circuit 242.

Please refer again to FIG. 1. The tool setting circuit 20 further includes a first output circuit 26 and a second output circuit 28. The first output circuit 26 is coupled between the motion module 10 and the signal control circuit 22. The second output circuit 28 is coupled between the electrolyte supply module 16 and the signal control circuit 22. When the signal control circuit 22 generates a motion control signal according to the change status of the electrical signal, the signal control circuit 22 transmits the motion control signal to the first output circuit 26. The first output circuit 26 transmits the motion control signal to the motion control circuit 102 of the motion module 10 for controlling the motion of the moving shaft 100. For example, the motion control signal generated by the signal control circuit 22 is a speed adjusting signal, for adjusting the moving speed of the machining electrode 12. Alternatively, the motion control signal is a stop signal, for controlling the machining electrode 12 to stop moving.

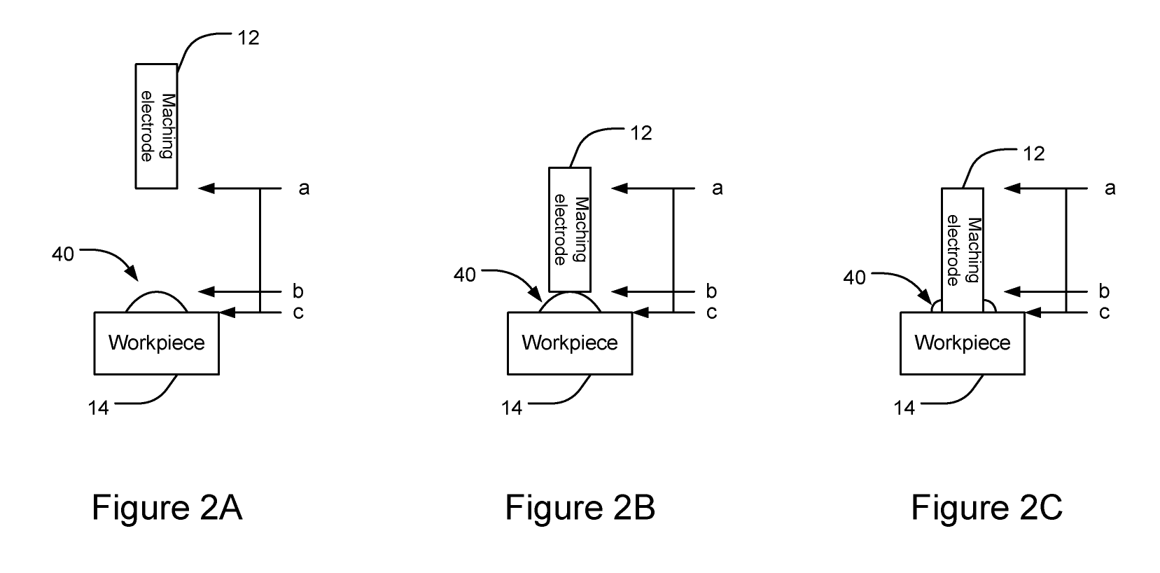

In addition, the signal control circuit 22 generates an electrolyte control signal and transmits the electrolyte control signal to the second output circuit 28. The second output circuit 28 transmits the electrolyte control signal to the electrolyte supply module 16. According to the electrolyte control signal, the electrolyte supply module 16 supplies electrolyte to the electrolyte output device 160 for start injecting electrolyte 40 to the surface of the workpiece 14, as shown in FIG. 2A.

Please refer to FIGS. 2A, 2B, and 2C, which show schematic diagrams of tool setting as the tool setting device for electrochemical machining according to the present invention moves the machining electrode. As shown in the figures, the machining electrode 12 can move to a first location a, a second location b, or a third location c. The machining electrode 12 starts from the first location a and moves to the workpiece 14 for performing the tool setting procedure. When the machining electrode 12 is at the first location a, the machining electrode 12 is away from the workpiece 14. When the machining electrode 12 moves to the second location b, the machining electrode 12 contacts the electrolyte 40 on the surface of the workpiece 14. When the machining electrode 12 moves to the third location c, the machining electrode 12 contacts the workpiece 14. Before the tool setting device moves the machining electrode 12 to perform the tool setting procedure, the signal control circuit 22 controls the power supply circuit 18 to supply the tool-setting power source to the machining electrode 12 and the workpiece 14 and to supply the power source to the detection circuit 30. In addition, the signal control circuit 22 controls the electrolyte supply module 16 to supply electrolyte to the electrolyte output device 160 and inject the electrolyte 40 to the surface of the workpiece 14.

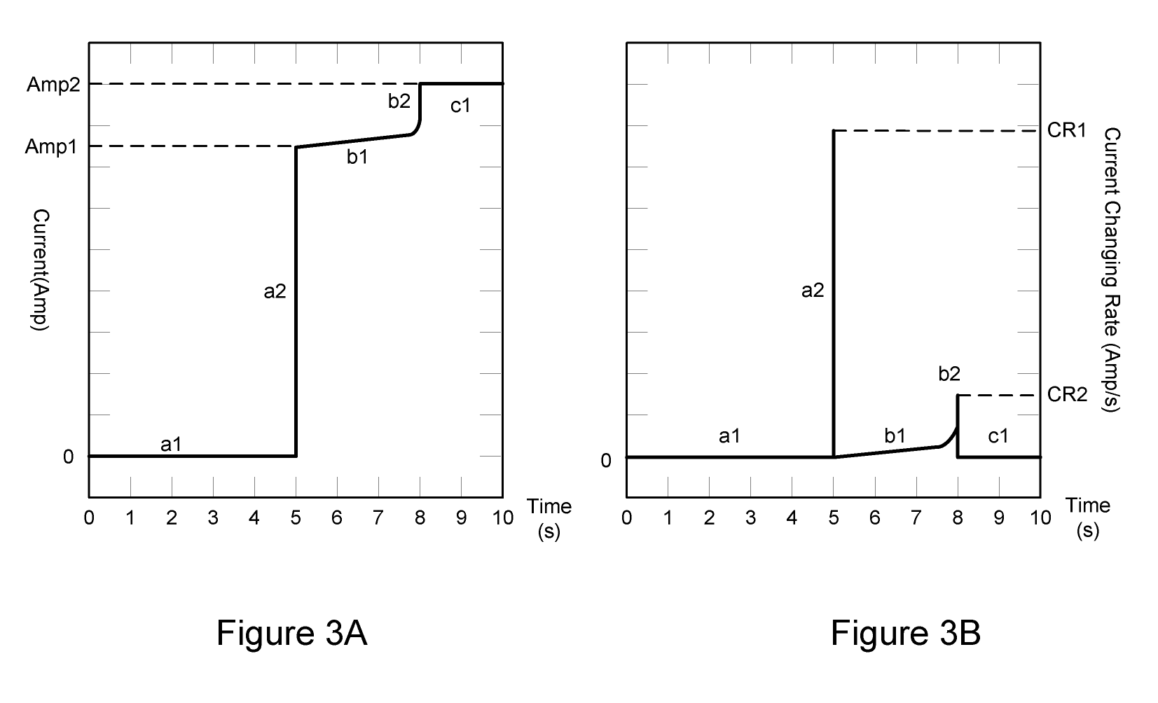

Before the machining electrode 12 moves from the first location a to the second location b, because the machining electrode 12 does not contact the electrolyte 40, the machining electrode 12 and the workpiece 14 does not form a circuit loop. In other words, the tool-setting power source supplied by the power supply circuit 18 cannot flow between the machining electrode 12 and the workpiece 14, given the environmental factors are not considered. As shown in FIG. 3A, in the first period al, the machining electrode 12 moves from the first location a to (but not reaches) the second location b. The detection circuit 30 continues to detect the electrical status of the machining electrode 12. Since the machining electrode 12 has not contacted the electrolyte 40, no current flow between the machining electrode 12 and the workpiece 14. Hence, in FIG. 3A, the first period al is labeled with zero current. In addition, after the machining electrode 12 continues to move for 5 seconds, as shown in FIG. 2B, the machining electrode 12 moves to the second location b and contacts the electrolyte 40 on the surface of the workpiece 14. Thereby, the machining electrode 12, the electrolyte 40 and the workpiece 14 form a circuit loop, boosting the current passing through the machining electrode 12. As shown in FIG. 3A, the detection circuit 30 detects the current passing through the machining electrode 12 at the instant a2 of the fifth second. The current value is, for example, Amp1.

Next, the machining electrode 12 continues to move from the second location b to the third location c. Before the machining electrode 12 reaches the third location c, it continues to move to but not touch the workpiece 14. Thereby, given the gap between the machining electrode 12 and the workpiece 14 becomes smaller, the current passing through the machining electrode 12 will increase gradually. As shown in FIG. 3A, in the second period b2 when the machining electrode 12 moves from the second location b to (but not reaches) the third location c, the current increase continuously from the value Amp 1 gradually. After the machining electrode 12 continues to move for three seconds, as shown in FIG. 2C, it moves to the third location c and contacts the surface of the workpiece 14. Hence, the machining electrode 12 contacts the workpiece 14 directly, boosting the current passing through the machining electrode 12. As shown in FIG. 3A, the detection circuit 30 detects the current value of Amp2 approximately passing through the machining electrode 12 at the instant b2 of the eighth second. Besides, the current value Amp2 is greater than the current value Amp 1, and the current value Amp1 is greater than zero.

Then, the machining electrode 12 stops moving. Because the machining electrode 12 keeps contacting the workpiece 14, the current passing thorough it does not change. As shown in FIG. 3A, in the third period c1 when the machining electrode 12 maintains contacting the workpiece 14, the current values is held at approximately Amp2.

According to the above description, as the machining electrode 12 changes the state from not contacting the electrolyte 40 on the surface of the workpiece 14 to contacting, for example, at the instant a2, it will experience drastic changes in its electrical status. For example, the current value flowing through the machining electrode 12 will be increased significantly and instantaneously. Furthermore, when the machining electrode 12 contacts the electrolyte 40 and changes the state from not contacting the workpiece 14 to contacting, for example, at the instant b2, the electrical status of the machining electrode 12 will change apparently as well. Namely, the current passing through the machining electrode 12 will be boosted apparently at the instant. Accordingly, when the tool setting circuit 20 is notified of the apparent change in the electrical signal generated by the detection circuit 30, it is known that the machining electrode 12 contacts the electrolyte 40 on the surface of the workpiece 14 or the machining electrode 12 has touched the workpiece 14.

Based on the above description, the operational circuit 246 of the signal processing circuit 24 performs calculations according to the electrical signal to give the change status of the electrical signal. According to an embodiment of the present invention, the operational circuit 246 differentiates the electrical signal with respect to time to give the changing rate of the electrical signal. As shown in FIG. 3B, in the first period a1, because the current value is maintained at zero, the changing rate of the electrical signal is zero. On the other hand, at time a2, the machining electrode 12 contacts the electrolyte 40. The current value is increased instantaneously from zero to approximately Amp1. The changing rate is approximately, for example, CR1. In the second period b2, because the current value detected by the detection circuit 30 is increased gradually from the current value Amp1, the changing rate of the electrical signal is increased continuously and gradually from zero as well. Then, at time b2, the machining electrode 12 contacts the workpiece 14. The current value is increased instantaneously and significantly from approximately Amp1 (but greater than Amp1) to Amp2. The changing rate is approximately CR2, which is smaller than the changing rate CR1. In the third period c1, because the current value is held at Amp2 approximately, the changing rate of the electrical signal is zero.

In the tool setting procedure in which the tool setting device moves the machining electrode 12, when the signal control circuit 22 detects the first change of the electrical signal according to the signal output by the operational circuit 246, it is known that the machining electrode 12 has already approached the workpiece 14 and contacted the electrolyte 40 on the surface of the workpiece 14. At this moment, the signal control circuit 22 can generate a speed adjustment signal for controlling the motion module 10 reduce the moving speed of the machining electrode 12. Next, when the signal control circuit 22 detects the second change of the electrical signal, it is known that the machining electrode 12 has already contacted the workpiece 14. The signal control circuit 22 generates a stop signal for controlling the motion module 20 to stop moving the machining electrode 12 and record the coordinates of the location of the machining electrode 12 for completing the tool setting procedure. According to the above description, the tool setting device can acquire the location of the machining electrode 12 with respect to the workpiece 14 according to the electrical signal generated by the detection circuit 30 and control the motion of the machining electrode 12 automatically. The motions according to the present embodiment include increasing the motion speed, reducing the motion speed, moving to the workpiece 14, stop moving, or moving away from the workpiece 14.

Moreover, the electrical signal will change due to some factors as well. Nonetheless, this change is less than the changes caused by the machining electrode 12 contacting the electrolyte 40 and the workpiece 14. Thereby, to avoid false judgment by the tool setting device, a first threshold and a second threshold can be set to the tool setting device. The first threshold can be used for judging if the machining electrode 12 contacts the electrolyte 40; the second threshold can be used for judging if the machining electrode 12 contacts the workpiece 14. The first and second thresholds can be determined according to the changing rates at time a2 and time b2 in FIG. 3B. According to the present embodiment, the first threshold is higher than the second threshold.

Initially, when the signal control circuit 22 judges that the changing rate of the electrical signal is greater than the first threshold, it is known that the machining electrode 12 has contacted the electrolyte 40 on the surface of the workpiece 14. If the signal control circuit 22 judges that the changing rate of the electrical signal is smaller than the first threshold, it is judged that the machining electrode 12 has contacted the electrolyte 40, and the signal control circuit 22 continues to judge if the machining electrode 12 has contacted the electrolyte 40 according to the changing rate. As the signal control circuit 22 judges that the machining electrode 12 has contacted the electrolyte 40, it continues to judge if the machining electrode 12 has contacted the workpiece 14 according to the changing rate. If the changing rate of the electrical signal is greater than the second threshold, the signal control circuit 22 judges that the machining electrode 12 has contacted the workpiece 14 and then controls the motion module 10 to stop moving the machining electrode 12. According to the above description, it is appropriate for the tool setting device to perform tool setting in a humid ambient.

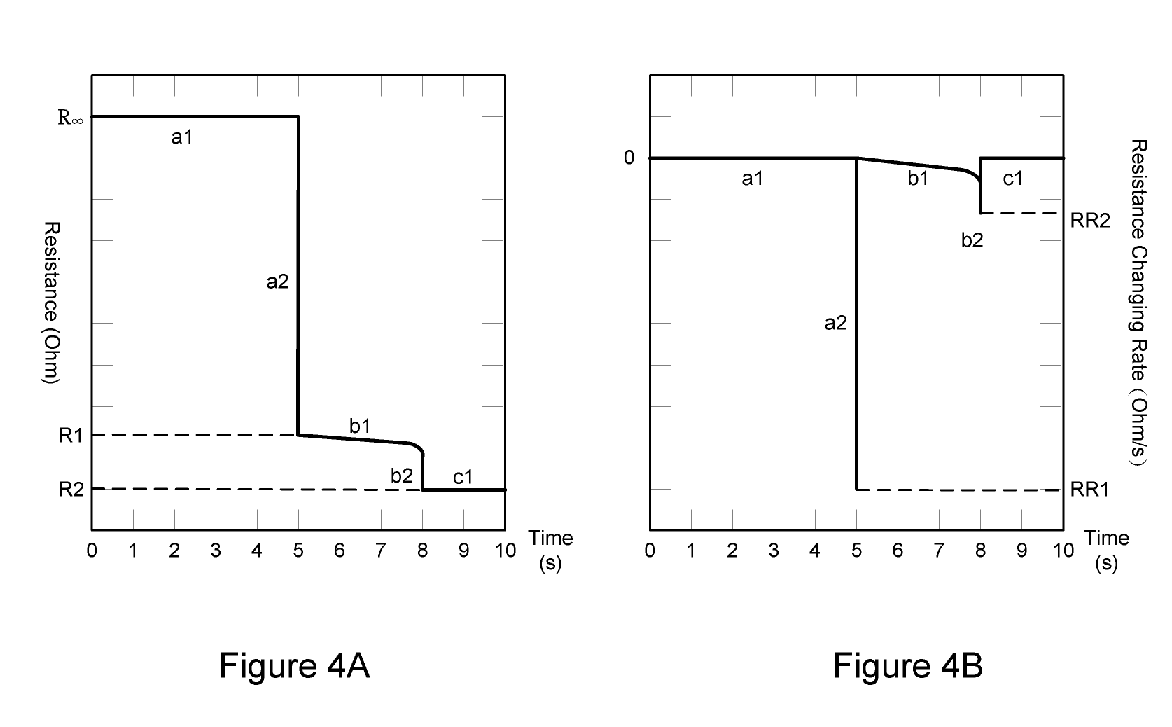

According to another embodiment of the present invention, the detection circuit 30 detects the electrical status of the machining electrode 12 and the generated corresponding electrical signal can be a resistance signal, representing the resistance status of the machining electrode 12. As shown in FIG. 4A, when the machining electrode 12 has not contacted the electrolyte 40 in the first period al, the machining electrode 12 and the workpiece 14 does not form a circuit loop via the electrolyte 40, leading to infinite resistance (R∞) between the machining electrode 12 and the workpiece 14. Next, the machining electrode 12 continues to move and contacts the electrolyte 40 at the instant a2. Since the machining electrode 12, the electrolyte 40, and the workpiece 14 form a circuit loop, the current flowing through the machining electrode 12 will be increased instantaneously, representing decrease in the resistance between the machining electrode 12 and the workpiece 14. As shown in FIG. 4A, the resistance becomes R1 approximately. Then, in the second period b2, when the machining electrode 12 continues to move and before contacting the workpiece 14, the resistance is maintained at R1 approximately. At time b2 when the machining electrode 12 contacts the workpiece 14, because the machining electrode 12 contacts the workpiece 14 directly, the current passing through the machining electrode 12 will be increased again, meaning that the resistance between the machining electrode 12 and the workpiece 14 becomes even smaller. As shown in FIG. 4A, the resistance becomes R2 approximately and the resistance R2 is smaller than the resistance R1.

Afterwards, the operational circuit 246 differentiates the electrical signal with respect to time and calculates the changing rates in resistance RR1, RR2. The differentiated electrical signal is shown in FIG. 4B. The changing rates in resistance RR1, RR2 shown in FIG. 4B are like the changing rates in current CR1, CR2. The difference is that the changing rates in resistance RR1, RR2 shown in FIG. 4B are negative while the changing rates in current shown in FIG. 3B are positive. As described above, the signal control circuit 22 can acquire the location of the machining electrode 12 with respect to the workpiece 14 according the changing rates in resistance RR1, RR2 for controlling the movement of the machining electrode 12.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A tool setting device for electrochemical machining, comprising:
a motion module, moving a machining electrode;
a detection circuit, detecting an electrical status of said machining electrode, and outputting an electrical signal; and
a tool setting circuit, performing calculations according to said electrical signal and giving a change status of said electrical signal, controlling said motion module according to said change status of said electrical signal.

2. The tool setting device for electrochemical machining of claim 1, wherein said tool setting circuit includes:
a signal processing circuit, coupled to said detection circuit, performing calculations according to said electrical signal, and giving said change status of said electrical signal; and
a signal control circuit, coupled to said signal processing circuit, controlling said motion module according to said change status of said electrical signal for controlling the moving speed of said machining electrode.

3. The tool setting device for electrochemical machining of claim 2, wherein said change status is a changing rate of said electrical signal; when said changing rate of said electrical signal is greater than a first threshold, said signal control circuit controls said motion module to reduce the moving speed of said machining electrode; when said changing rate of said electrical signal is greater than a second threshold, said signal control circuit controls said motion module to stop said machining electrode; and said first threshold is greater than said second threshold.

4. The tool setting device for electrochemical machining of claim 3, wherein when said machining electrode does not contact an electrolyte on a surface of a workpiece, said changing rate of said electrical signal is smaller than said first threshold and said second threshold; when said machining electrode changes the state from not contacting said electrolyte on said surface of said workpiece to contacting said electrolyte, said changing rate of said electrical signal is greater than said first threshold; and when said machining electrode changes the state from contacting said electrolyte on said surface of said workpiece but not contacting said workpiece to contacting said workpiece, said changing rate of said electrical signal is greater than said second threshold.

5. The tool setting device for electrochemical machining of claim 2, wherein said signal processing circuit includes an operational circuit, performing calculations according to said electrical signal to give said changing status of said electrical signal.

6. The tool setting device for electrochemical machining of claim 5, wherein said signal processing circuit includes:
a signal conversion circuit, coupled to said detection circuit, and converting said electrical signal from an analog signal to a digital signal; and
a filter circuit, coupled between said signal conversion circuit and said operational circuit, filtering said digital electrical signal, and transmitting said filtered electrical signal to said operational circuit.

7. The tool setting device for electrochemical machining of claim 1, wherein said tool setting circuit includes:
a signal control circuit, generating a speed adjusting signal according to said change status of said electrical signal and a first threshold, generating a stop signal according to said change status of said electrical signal and a second threshold; and said first threshold greater than said second threshold;
a first output circuit, coupled between said signal control circuit and said motion module, and transmitting said speed adjusting signal or stop signal to said motion module for reducing the moving speed of said machining electrode or stop moving said machining electrode;
a second output circuit, coupled to said signal control circuit for transmitting an electrolyte control signal generated by said signal control circuit;
an electrolyte supply module, coupled to said second output circuit, and supplying an electrode according to said electrolyte control signal; and
a power supply circuit, coupled to said signal control circuit, receiving a power control signal generated by said signal control circuit, and supplying a tool-setting power source to said machining electrode according to said power control signal.

8. A tool-setting method for electrochemical machining, comprising steps of:
moving a machining electrode;
detecting an electrical status of said machining electrode, and outputting an electrical signal;
performing calculations according to said electrical signal, and giving a change status of said electrical signal; and
controlling the moving speed of said machining electrode according to said change status of said electrical signal.

9. A tool-setting method for electrochemical machining of claim 8, wherein said change status is a changing rate; when said changing rate of said electrical signal is greater than a first threshold, reduce the moving speed of said machining electrode; when said changing rate of said electrical signal is greater than a second threshold, control said machining electrode to stop moving; and said first threshold is greater than said second threshold.

10. A tool-setting method for electrochemical machining of claim 8, wherein said step of performing calculations according to said electrical signal and giving a change status of said electrical signal includes differentiating said electrical signal to give a changing rate of said electrical signal; reducing the moving speed of said machining electrode according to said changing rate of said electrical signal, or controlling said machining electrode to stop moving according to said changing rate of said electrical signal.
